(19) United States
(12) Patent Application Publication
(10) Pub. No.: US 2003/0077376 A1
(43) Pub. Date: Apr. 24, 2003

(54) Boneless spiral sliced meat product and method of slicing the same

(76) Inventor: James Pinckney Logan JR., Richmond, TX (US)

Correspondence Address: Robert M. Bowick, THE MATTHEWS FIRM, Suite 1800, 1900 West Loop South, Houston, TX, 77027, US

(21) Appl. No.: 10/040,163

(22) Filed: Oct. 19, 2001

(51) Int. Cl. A23L 1/31

(52) U.S. Cl. 426/645

(57) ABSTRACT

A boneless meat product and method for making such product, including hams and other boneless meat, the meat being spirally sliced around an axis through the meat. The axis is created by the insertion of a temporary support member through the meat. The meat is mounted in meat slicing apparatus which rotates the meat. A slicer blade is introduced into the meat in a plane substantially perpendicular to the axis of rotation while the meat is rotating. The slicer blade is then indexed linearly along an axis parallel to the axis of rotation of the meat, thereby effecting a spiral cut in the meat. The meat is removed from the apparatus following slicing operations and the support member removed from the meat.

### BACKGROUND OF THE INVENTION

1. Field of the Invention

The present invention relates to an improved apparatus for the spiral slicing of boneless meat products and, more particularly, the improved apparatus relates to an accessory for use with a spiral meat slicing machine designed for effecting a spiral slice cut in a ham, beef roast, turkey or the like.

2. General Background

There exists a number of different apparatus for spiral slicing of meats, such as hams or roasts, about the bone located in the cut of meat. These devices have a number of common features. First, they typically include a rotating chuck assembly. The chuck assembly is driven by some motorized means and is designed to hold the meat to be cut, thereby rotating the meat about the chuck assembly rotational axis. Second, the device, includes a saw blade, disposed in a plane generally perpendicular to the rotational axis of the chuck assembly and including a means for driving the saw blade, for cutting the meat. To facilitate the mechanics of the cutting process, provisions are generally made for adjusting the position of the saw blade relative to the stated plane. Third, the device includes a means of gradually linearly indexing the saw blade assembly relative to the meat. The index axis is typically parallel to the chuck assembly rotational axis. Lastly, the saw blade assembly typically includes a means for rotating a circulating saw blade about the index axis or else a reciprocating saw blade, thereby laterally positioning the saw blade and bringing the blade into cutting engagement with the meat. The rotation of the meat, when in contact with the saw blade, and the linear indexing of the blade relative to the meat, effect a generally continuous spiral cut of the meat about a bone or central longitudinal axis.

As spiral sliced meat products have become increasingly popular, such devices have been developed for producing a continuous spiral slice in a cut of meat having a center bone therein. Examples of such devices include Hoenselaar U.S. Pat. No. 2,470,078; Hoenselaar U.S. Pat. No. 2,599,328; Chesley U.S. Pat. No. 3,153,436; Frentzel U.S. Pat. No. 3,951,054; Schmidt et al U.S. Pat. No. 4,050,370; Urban U.S. Pat. No. 4,287.820; Mart U.S. Pat. No. 4,332,192; Hoegh U.S. Pat. No. 4,412,483; and Mullins, Jr. U.S. Pat. No. 4,441,411.

However, all of these devices rely on the center bone to provide structural support for the meat. These devices cannot be used with a boneless cut of meat which has no support structure of its own.

This problem was addressed by Logan, Jr. U.S. Pat. Nos. 4,821,635, 5,030,472, and Re. 35,374. Logan, Jr. discloses a meat slicing apparatus in which a meat spit is provided between the upper and lower chucks for supporting a boneless cut of meat. Such devices typically include upper and lower pronged chucks for holding the meat while it is rotated about a longitudinal axis passing through the chucks, and a rotating blade or reciprocating knife which is indexed to move upwardly or downwardly as the meat is rotated.

Additionally, Brother's U.S. Pat. No. 5,251,543 discloses an accessory for supporting a boneless cut of meat for use in conjunction with a spiral meat slicer having an upper support bracket and a rotatable turntable. However, the Brother's device is limited to the use of both adjustable upper prong members and lower vertically adjustable lower stop member slidably carried by a cruciform shaped spit.

Accordingly, a meat slicing accessory is desired which does not suffer from the disadvantages of these prior art systems and which facilitates the creation of an improved boneless spiral sliced cut of meat. The present invention is designed to overcome the above problems and also provides an improved method for spiral cutting boneless meats.

### SUMMARY OF INVENTION

Briefly, the present invention provides a new improved meat slicing accessory, capable of effecting a spiral cut in hams or other meats, including boneless meats. The accessory is to be utilized with a rotating meat chuck assembly for holding the meat and rotating the meat about the rotational axis of the chuck assembly during cutting operations; a blade generally disposed in a plane perpendicular to the chuck rotational axis for cutting the meat; a linear indexing system for moving the slicer blade along an axis parallel to the chuck rotational axis; a positioning system for moving the slicer blade into cutting engagement with the meat; a rotational stop which will limit blade engagement during boneless meat cutting operations and an improved meat spit adapted to fit within a chuck assembly and provide structural support for boneless meats during cutting operations.

The chuck assembly is designed to hold and rotate the meat during cutting operations. The chuck assembly is also designed to receive a meat spit, which is inserted into the assembly along the chuck assembly rotational axis. The meat spit is inserted into boneless cuts of meat and is designed to provide structural support for the meat during boneless cutting operations. The ability to spirally slice boneless meats does appear in the prior art but the present invention represents an improved commercial application for spiral slicing apparatus.

The linear indexing means generally include a threaded drive shaft, disposed along a linear index axis, parallel to the chuck rotational axis. The drive shaft rotates at a precisely controlled variable rate and direction in response to rotation of a motor, wherein the motor direction and rate are controlled by a motor controller. The rotation of the drive shaft is translated into motion along a linear index axis which in turn moves a blade rotator sleeve along the linear index axis. A blade assembly is mounted on the first end of the blade sleeve, the slicer assembly generally includes a motor, blade support arm and a slicer blade which is pendently disposed on the first end of the blade support arm in a plane generally perpendicular to both the chuck rotational axis and the linear index axis.

The blade positioning system is a rotating system linked to the blade rotator sleeve, wherein activation of the system causes the blade rotator sleeve to rotate about the linear index axis, so as to cause the slicer blade engage or disengage the meat. During boneless cutting operations, a spit nut stop is threaded onto an externally threaded nut mounted on the face of the positioning system cylinder. The stop limits rotation of the blade's rotator sleeve during boneless meat slicing operations, thereby limiting movement of the slicing blade to within ⅛ of an inch of the meat spit inserted into the meat as described above. The positioning means permits the engagement force to be readily overcome, thereby preventing the blade from cutting into bones or joints in the meat which are located eccentric with respect to the chuck axis of rotation.

### BRIEF DESCRIPTION OF THE DRAWINGS

FIG. 1 is a perspective view, partially in section, of a spiral meat slicer provided with an accessory for supporting a boneless cut of meat in accordance with the present invention.

FIG. 2 is an enlarged view of the meat chuck assembly including the accessory of the present invention.

FIG. 3 is an exploded view of the improved accessory of the present invention.

FIG. 4 is an enlarged view of the improved accessory of the present invention.

FIG. 5 is a cross-sectional view taken along line A of FIG. 4.

FIG. 6 is a view of the optional upper chuck assembly spacer assembly.

FIG. 7 is a pictorial representation of a spirally sliced boneless meat product.

FIG. 8 is an illustration of the interaction between the threaded drive shaft, rotator sleeve and pneumatic cylinder of a boneless spiral meat slicing apparatus.

FIG. 9 is a schematic of the electrical and pneumatic systems of a boneless spiral meat slicing apparatus.

### DETAILED DESCRIPTION OF THE INVENTION

In describing a preferred embodiment of the present invention illustrated in the drawings, specific terminology is employed for the sake of clarity. However, the invention is not intended to be limited to the specific terminology so selected, and it is to be understood that each specific element includes all technical equivalents which operate in a similar manner to accomplish a similar purpose.

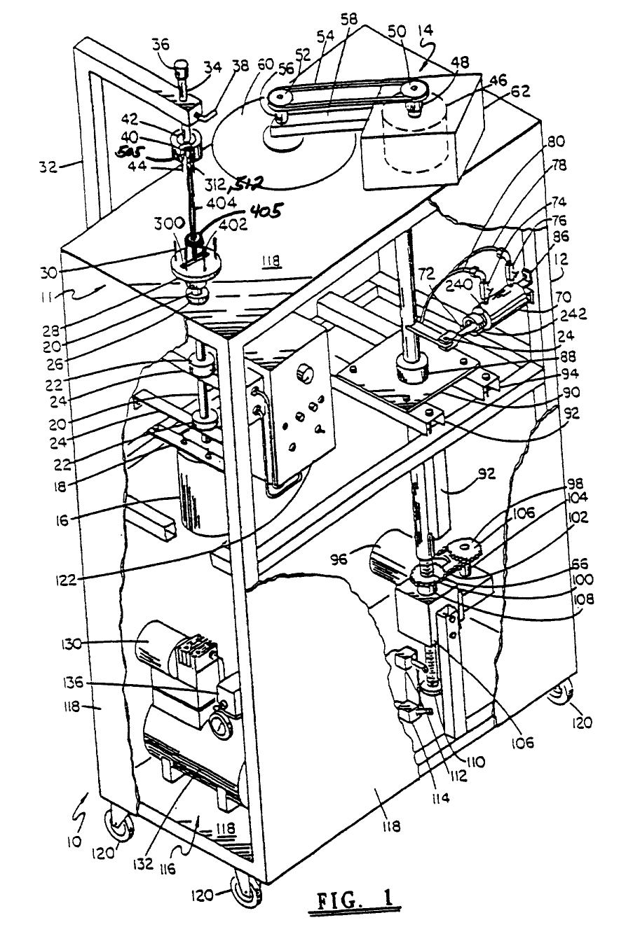

Referring now to FIG. 1, there is a partial depiction of a meat slicing apparatus 10 for spiral slicing a boneless cut of meat of the type disclosed in Logan, Jr. U.S. Pat. Nos. 4,821,635, 5,030,472, and Re. 35,374, which is expressly incorporated herein by reference in their entireties. Apparatus 10 comprises a knife blade 60 which includes a meat chuck assembly 11, a positioner assembly 13, a slicer assembly 14, linear indexing assembly 15 and a main frame 12 used to support the chuck and slicer assemblies 11 and 14 and other components of the apparatus.

Referring now to the main frame 12, shown in FIG. 1, the frame 12 is composed of a plurality of support beams 92 which form a base for the slicer assembly 10. The frame 12 includes a plurality of support beams which traverse the inner space defined by the frame 12, so as to provide support for various components described hereinafter. The frame further includes cover plates 118, which form a floor, top plate and side plates to the frame. Mounted internal of main frame 12 is an electrical control module, which provides a housing for a plurality of electrical components described hereinafter.

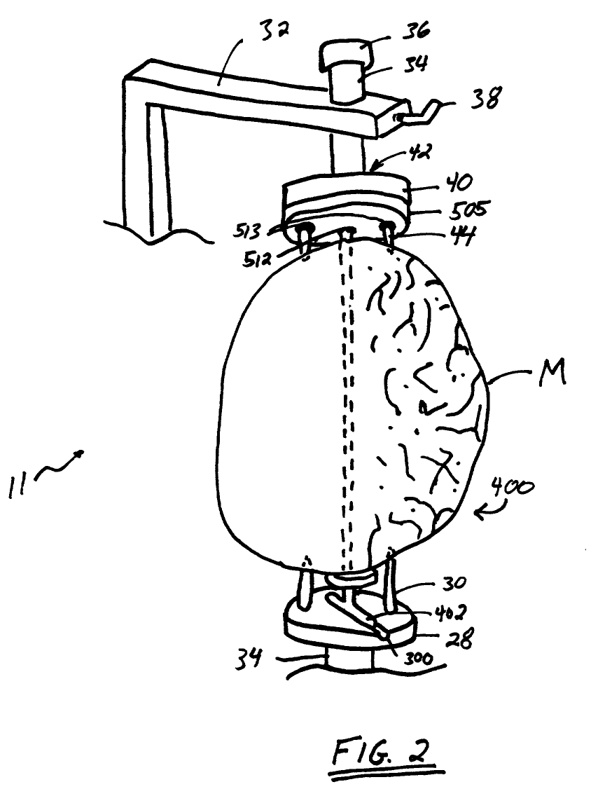

Referring now to the chuck assembly 11, shown in FIGS. 1 and 2, having upper and lower assemblies. The upper chuck assembly includes generally L-shaped support arm 32, which is connected to main frame 12. A chuck support shaft 34, having a stop 36 on its upper end, and a hole 312 dimensioned for receiving the meat spit 400 stem member 404 and providing a mechanism for transmitting torque for rotation of the upper chuck 40 therein on its lower end, which extends through the support arm 32. A threaded chuck lock 38 extends through and is in threaded engagement with the end of chuck support arm 32 and may be rotated to be brought into contact with chuck support shaft 34 to prevent movement of chuck support shaft during operations. A bearing 42 is mounted on the other end of the support shaft and carries an upper chuck 40, having a plurality of prongs 44 mounted perpendicular to the face of the chuck 40, to permit rotation of chuck 40. The upper chuck 40 includes a hole 312 dimensioned for receiving the meat spit 400 stem member 404 and providing a mechanism for transmitting torque for rotation of the upper chuck 40. The hole 312 extends through upper chuck 40 to receive the stem member 404 of meat spit 400. An optional spacer member 505 may be attached to the upper chuck 40. This spacer member 505 is in slidable engagement with plurality of prongs 44 extending downwardly from the face of the chuck 40. The optional spacer member 505 also has a hole 512 dimensioned for receiving the meat spit 400 stem member 404 and further providing a mechanism for transferring torque for rotation of the upper chuck 40 extending therethrough for receiving the stem member 404 of the meat spit 400 and holes 513 for receiving a plurality of prongs 44.

The lower chuck assembly includes an electrical motor 16. which is mounted on frame 12 and support beams 92 within frame 12 by means of a motor mount 18. The chuck motor 16 includes a drive shaft 20 which extends through an upper plate 118 of the slicing apparatus 10. A bearing 26 is provided for on the upper plate 118 to reduce friction as the shaft 20 rotates. The motor shaft 20 is interconnected with the lower chuck 28, having a plurality of prongs 30 aligned perpendicular to the face of lower chuck 28, and is in coaxial alignment with chucks 28 and 40, and chuck support shaft 34, thereby defining a chuck rotational axis. The lower chuck 28, having a slot 300 therein, is designed to receive tee member 402 of meat spit 400 in slot 300. The meat spit 400 is used in the slicing of boneless meats to provide support by inserting stem member 404 into the meat during slicing operations. Upon activation of motor 16, the lower chuck 28 is caused to rotate by drive shaft 20, thereby rotating any meat disposed between chucks 28 and 40 about the chuck rotational axis. The meat spit 400 further comprises a vertically support plate 405 on the stem member 404 of the meat spit 400 for supporting a boneless meat product.

FIG. 2 depicts a boneless meat M product having meat spit 400 inserted therein. The stem member 404 of spit 400 forms an axis through the meat M for slicing operations and the support plate 405 supports the boneless meat product above the tee member 402. The meat spit 400 has a generally hexagontal apex 404 and a conical tee member 402. Meat spit 400 is affixed to the tee member 402, for example by welding.

Referring now to the slicer assembly 14 in FIG. 1, a circular slicer blade 60, having a blade shaft 56 and a blade pulley 52, is disposed in a plane generally perpendicular to the chuck rotational axis. The blade shaft 56 is interconnected to a blade support arm 58, which is in turn connected to a slicer motor housing 62, in a manner to permit the blade shaft to rotate, thereby permitting the circular slicer blade 60 to also rotate. An electrical motor 46, having a motor drive shaft 48 and motor pulley 50, is mounted within the slicer motor housing 62 with the drive shaft 48 essentially parallel with the chuck rotational axis. A belt 54 is routed between the blade pulley 52 and motor pulley 50, such that activation of motor 46 will rotate motor pulley 52, thereby causing circular slicer blade 60 to rotate.

Still referring to FIG. 1, the linear indexing assembly 15 is used to move the slicer blade assembly 14 parallel to the axis of the rotation of the chuck assembly 11. An electrical indexing motor 96 is mounted on the main frame 12 of the slicing apparatus 10. A motor drive shaft 104 and sprocket member 98 are connected to the indexing motor 96 and aligned parallel to the chuck assembly 11 axis of rotation. A threaded indexing shaft 66 extends through a sprocket support bearing 108, also along an axis parallel to chuck assembly 11 axis of rotation. The sprocket support bearing 108 is mounted on a sprocket support housing 106, which is in turn mounted on main frame 12. The sprocket support bearing 108 is also threaded through a second drive sprocket 100. Drive sprockets 100 and 98 are interconnected by a drive chain 102. A limit switch trip plate 110 is mounted on the lower end of the threaded shaft 66. Energation of motor 96 will cause motor drive shaft 104 and sprocket 98 to rotate imparting rotation to sprocket 100 by means of drive chain 102. The rotation of sprocket 100 in turn rotates sprocket support bearing 108, the rotation thereby causing threaded shaft 66 to move in a linear direction dependent upon the direction of motor rotation parallel to the chuck assembly 11 rotation axis. An upper limit switch 112 and a lower limit switch 114 are disposed about switch trip plate 110 in a position corresponding to the corresponding desired upper and lower indexing positions. Switch plate 110 coming in contact with either limit switch 112 or 114 will result in the de-energization of index drive motor 96, thereby preventing any further linear motion.

Still referring to linear indexing assembly 15, shown in FIG. 1. a bearing support plate 90 is mounted within main frame 12, in a plane perpendicular to the motion of threaded shaft 66, by means of a plurality of support beams 92. The bearing support plate 90 in turn carries a pillow block bearing 88, through which is extended a blade rotator sleeve 64, having a slot 69 therein, as operation to provide the desired spiral slicing will noes be described in greater detail with reference FIG. 8. One end of the blade rotator sleeve 64 is interconnected to slice blade assembly 11 by connecting blade rotator sleeve 64 to slicer motor housing 62 in a suitable fashion. The other end of rotator sleeve 64 is interconnected to threaded shaft 66 is transmitted through blade rotator sleeve 64, thereby causing the slicer blade assembly 14 to move along an axis parallel to chuck assembly 11, in a direction dependent on the direction of rotation of drive motor 96.

A pneumatic positioner assembly 13 is also shown in FIG. 1. A dual chamber pneumatic cylinder 70, having a cylinder rod 72, is mounted on main frame 12 by means of a bracket 86, in a plane perpendicular to the linear movement of threaded shaft 66. The cylinder rod 72 is connected by a pin 74 to a blade rotator arm 220. The blade rotator arm 220 includes a body 63, an offset are 222 and a tongue 61, and fits over the blade rotator sleeve 64, as more clearly shown in FIG. 8. A pair of pneumatic supply hoses 78 and 80 are connected to pneumatic cylinder 70 through a pair of valves 76 and 74, respectively. Mounted on floor 118 of main frame 12, is an air compressor assembly 116, consisting of a compressor motor 130, an air reservoir 132, and an air compressor switch 136. The supply hoses 78 and 80 are connected to air reservoir 132 by means of a two position air valve 232 and air pressure regulator 230, as more clearly shown in FIG. 9. The energization of pneumatic cylinder 70, through supply line 78 and air valve 76 causes cylinder rod 72 to move in an outward direction, thereby imparting a clockwise rotation, about the axis of linear motion, to the rotator arm 220, which in turn transmits the rotational motion to blade rotator sleeve 64 and slicer blade assembly 14, which will move the slicer blade 60 away from any meat disposed in the chuck assembly 11. Conversely, energization of pneumatic cylinder 70 through supply line 80 and air valve 74 will cause he cylinder rod 72 to retract into the pneumatic cylinder 70, thereby imparting a counter-clockwise rotation, about the axis of linear motion, to the rotator arm 220, which in turn transmits the rotational motion to the blade rotator sleeve 64 and slicer blade assembly 14 which will move the slicer blade 60 toward any meat disposed in the chuck assembly 11.

The pneumatic cylinder 70 is provided with an externally threaded nut 240, which is affixed to the face of cylinder 70 and coaxially aligned with cylinder rod 72. The threaded nut 240 may be attached to the face of the pneumatic cylinder 70 by spot welding or other means. A split nut 242 is also provided as shown in FIG. 8, which permits the split nut to be positioned around cylinder rod 72 and threadedly engage the threaded nut 240. The split nut stop 242, therefore, limits movement of the offset arm 222, which in turn, limits the rotational movement of the slicer assembly 14. The split nut 242 is mounted on pneumatic cylinder 70 during boneless slicing operations and is designed to restrict the lateral motion of the slicer assembly 14, such that the slicer blade 60 is restricted to moving within ⅛ of an inch of the meat spit 400.

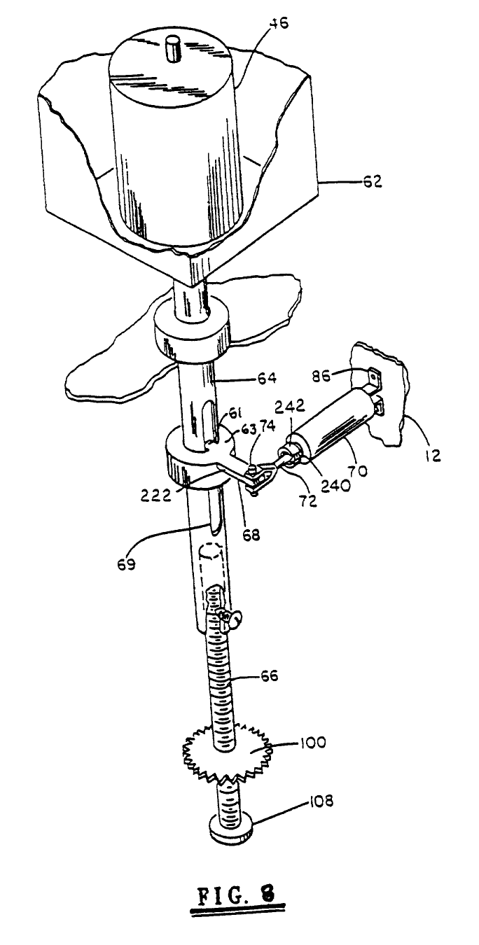

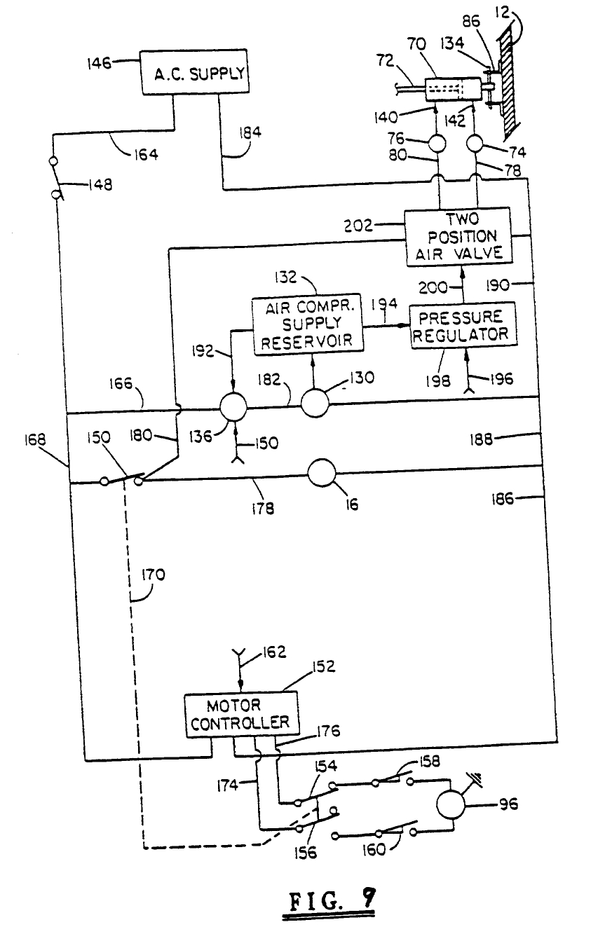

FIG. 7 depicts a spirally sliced boneless meat product M, having spit 400 removed following spiral slicing operations. A central core of uncut meat 600 runs through the meat thus permitting the meat to retain its shape.

Referring to FIG. 1, it will be appreciated that at times, it is desirable to manually override the force which brings slicer blade 60 into engagement within the meat held between chucks 28 and 40 as, for example, when the eccentrically-oriented aitch bone within the eat traverses about the chuck rotational axis. When the meat has rotated to the location where the eccentrically-oriented bone will come in contact with slice blade 60, blade support arm 58 may be moved slightly in a clockwise direction so as to override the force introduced by rode 72, causing blade 60 to otherwise move towards the meat. It is a feature of the present invention that the force bringing slicer blade 60 towards the meat is provided by pneumatic pressure within the cylinder housing 70 as opposed to hydraulic pressure of a relatively incompressible fluid.

Accordingly, the force required to overcome the force provided by cylinder rod 72 is greatly reduced as the operator is forcing the piston within housing 70 in a direction toward the high pressure side of the piston, thus compressing the air within the cylinder housing 70. In this manner, operator fatigue is reduced, and enabling the operator to cause the blade 60 to gently ride over the outer circumference of the aitch bone so as to avoid severing of the bone or joint and ruining the meat cut.

Moreover, the utilization of pneumatic force in moving slicer blade 60 towards meat, the operator may be more readily capable of sensing or feeling through blade 60 and support arm 58 the relative position of the outer circumference of the bone or joint as it rotates about the chuck assembly rotational axis. This is in contrast to the prior apparatus using a relatively incompressible or liquid hydraulic fluid drive.

It will be appreciated that it is generally desirable for slicer blade 60 to maintain slight engagement or to be substantially close to the outer circumference of the bone so as to provide slicing of the meat all of the way to the bone and that as the meat rotates, the distance between the outer circumference of the bone facing slicer blade 60 and slicer blade 60 would otherwise vary due the eccentricity of the bone if slicer blade 60 were to remain stationery .The movement of slicer blade 60 towards and away from the meat is necessary during slicing operations to compensate for this eccentricity and to maintain slicer blade 60 in light contact with or in close proximity to this outer circumference of the bone. Thus, during normal slicing operations, slicer blade 60 will move outwards away from the meat and inwards toward the meat once per revolution of the meat. In prior hydraulic systems, wherein the operator had to provide such outward movement of slicer blade 60 by force against a hydraulic system, this was quite tiresome. Moreover, due to the relative lack of compressibility of hydraulic fluid, hydraulic systems or circuit leakage was the only means available for providing some movement or give in the movement of slicer blade 60 by manual override which was generally insufficiently slight and cause undo work for the operator over a plurality of slicing operations. However, with the present invention, the force provided by the cylinder housing 70 to bring slicer blade 60 towards the meat may be overcome much more easily inasmuch as air or some other pneumatic fluid is being compressed by the operator by the movement of support arm 58 away from the meat. Moreover, inasmuch as more “give” is afforded by a pneumatic cylinder rather than a hydraulic one, the operator is much more readily able to cause blade 60 to maintain a very light engagement with the outer circumference of the bone or joint of the meat.

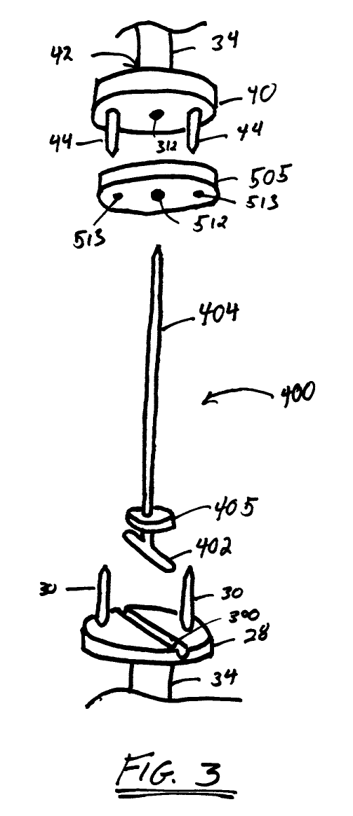

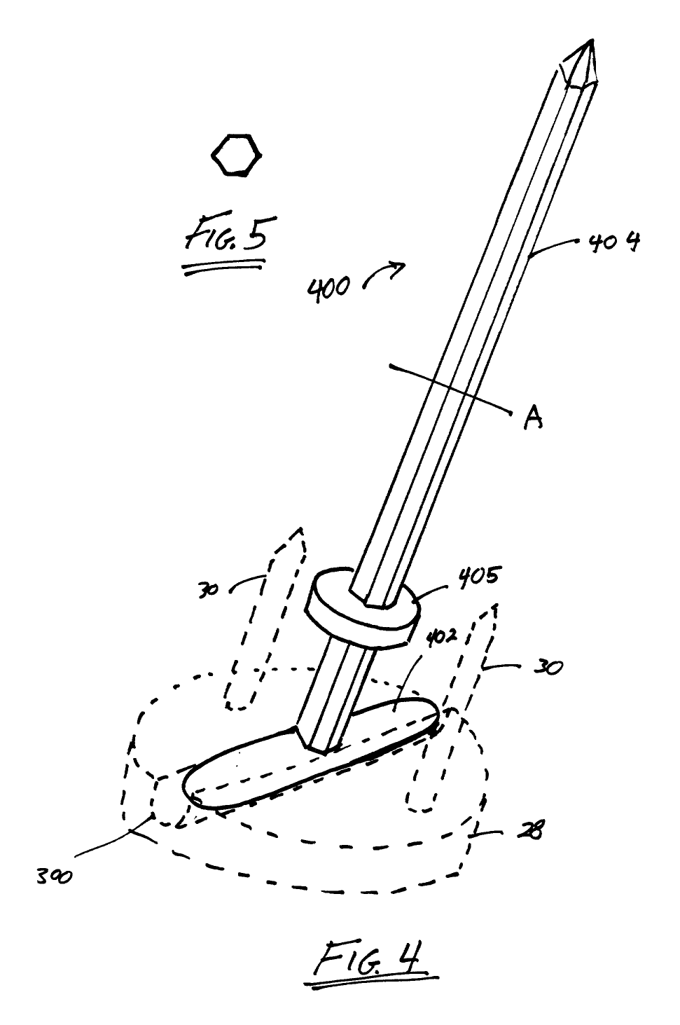

The manner in which the slicer assembly 14 is gradually indexed upwards and downwards during the slicing operation to provide the desired spiral slicing will no be described in greater detail with reference to FIG. 8. A more detailed view of the blade rotator sleeve 64 as shown in FIG. 3, reveals that a slot 69 provided therein. A more detailed view of the blade rotator sleeve 64 as shown in FIG. 3 reveals that a slot 69 provided therein. Also, in the embodiment shown in FIG. 8, a sleeve offset arm 222 may include a torroidal shape slide member 63 circumscribing the outer surface of the rotator sleeve 64 and having a tongue portion 61 extending into the vertically aligned slot 69. In this manner, the rotator sleeve 64 is permitted to move vertically with the respect to offset arm 222. However, due to tongue 61 of torroid member 63 extending into slot 69, upon actuation of the piston within cylinder housing 70, the stroke of cylinder rod 72 may be transmitted through pin 74 to offset arm 222 so as to cause rotation of the rotator sleeve 64 about the linear indexing axis in the desired direction. Therefore, the linear movement of rod 72 is transmitted through pin 74 to the offset arm 222 and converted into torque delivered by the tongue of 61 of the torroidal member 63 to rotator sleeve 64.

Still referring to FIG. 8, rotator sleeve 64 is also desirably hollow and has an internal thread which receives the outer threads of shaft 66. Alternatively, a set screw may be provided extended through the wall of rotator sleeve 64 which follows the outer thread of shaft 66. In other of these manners, upon rotation of shaft 66 about the linear index, axis by means of aforementioned sprocket drive assembly including sprockets 98, 100, and drive chain 102, as shown in FIG. 1, this rotation will be imparted to the rotator sleeve 64 so as to move the sleeve upwards and downwards gradually. Moreover. the sleeve 64 will be preferably interconnected to the motor housing 62 through appropriate bearings such as pillow block bearing 88 and like bearings which may be provided between the upper cover 118 and the lower portions of the motor housing 62. In this manner. as shaft 66 indexes in response to rotation of motor 96, the motor housing 62 and slicer assembly 14 may be raised upwards or downwards in a gradual linear indexing fashion at a rate controlled by the speed of motor 96. Thus, it will be appreciated that the relative rotational rate of chuck assembly 11 in relation to the linear movement rate of slicer assembly 60 will regulate the thickness of slices of the meat. Moreover, because the vertical movement of rotator sleeve 64 is controlled by direct drive from motor 96 and a mechanical linkage therefrom, the rotator sleeve 64 and ultimately slicer blade 60 will remain indefinitely in the vertical position they were in prior to de-energizing motor 96.

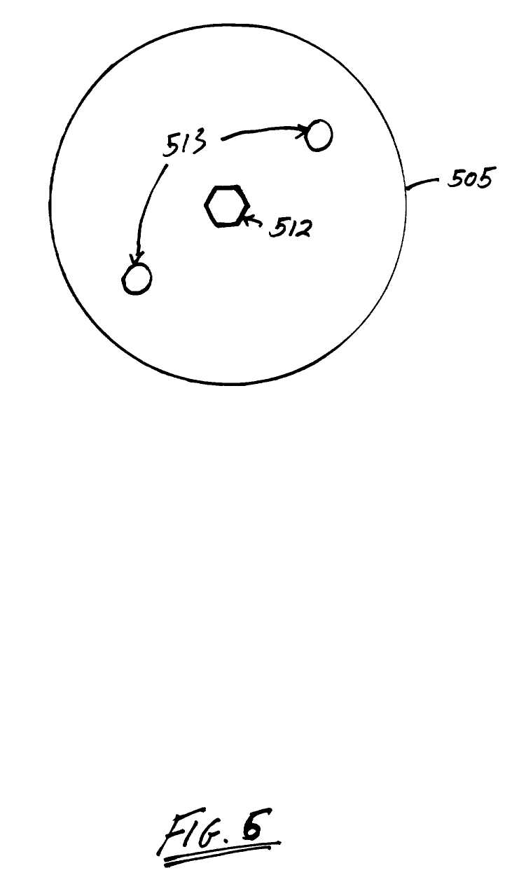

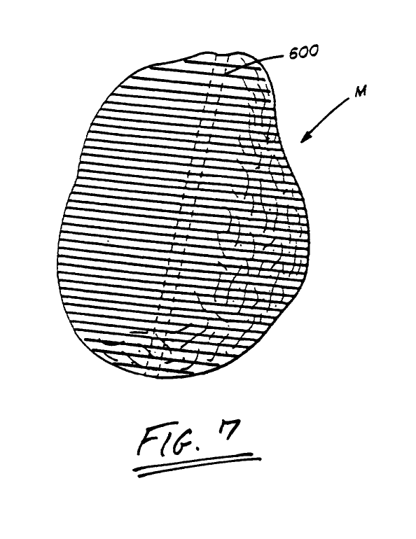

Referring now to FIGS. 5 and 6, the meat spit 400 stem member's 404 cross sectional area and corresponding hole 512 in the spacer member 505 can be of any shape suitable for delivering torque to the upper chuck member such as cruciform, quadralateral, pentagon, or the like.

To summarize the operation of the present invention, a meat spit is inserted in the meat to be cut and fitted into upper and lower chucks 40 and 28. The meat is then positioned between chucks 28 and 40, with the tee member 402 of spit 400 positioned in slot 300 and the stem member 404, in hole 312. A split nut 242 is fitted over cylinder rod 72 and threaded onto externally threaded nut 240 which is on the fact of the cylinder housing 70, thereby limiting the movement of cylinder rod 72 to prevent slicer blade 60 from coming into engagement with meat spit 400. The meat is disposed between chucks 28 and 40 and held by the plurality of spikes located thereon. The meat is then rotated about the chuck assembly axis by means of electrical motor 16 which is in turn controlled by motor controller 152. The slicer assembly 14 and slicer blade 60 are caused to index in a vertical fashion upon energization of motor 96 which in turn drives shaft 66 through sprockets 98, 100 and drive chain 102. The slicer blade is brought into engagement with the meat by energization of pneumatic cylinder 70 through line 142 causing cylinder rod 72 to linearly index and apply torque to blade rotator shaft 64 by means of blade rotator arm 220 and pin 74. The rotation of meat in chuck assembly 11 and the linear indexing of the slicer assembly 14, thereby effect a spiral cut on the meat disposed int he chuck assembly 11. The engagement force provided by means of pneumatic cylinder 70 may be overcome readily by means of a handle connected to blade support arm 58. Upon de-energization of the slicer assembly 1 will maintain its relative vertical position prior to de-energization. Slicing operations may be recommenced with the slicer assembly 1 maintaining the same position and reengaging the meat to maintain the same spiral cut.

It is therefore apparent that the present invention is adapted to obtain all of the advantages and features hereinabove set forth. It will be understood that certain combinations and subcombinations are futility and may be employed without reference to other features and subcombinations. Moreover the foregoing disclosure and description of the invention are illustrative and explanatory thereof are not designed to be limiting as to the scope of the represent invention.

I claim:

1. A boneless sliced meat having its meat arranged in the form of a continuous spiral cut about an axis of the meat, the axis being created by the temporary insertion of a support member in the meat, wherein the depth of said cut is limited to leave an uncut core of meat, said core being of sufficient cross-section to cause the boneless sliced meat to retain its shape when the support member is removed.

2. A boneless sliced meat product of claim 1, wherein said product being made by the process of inserting a temporary support member through the meat product, rotating the meat product around the axis of the support member, moving a blade into the meat product, adjacent one end of the support member, with the blade lying in a plane substantially perpendicular to the longitudinal axis of the support member, moving the blade along an axis parallel to the axis of rotation of the support member to produce a spiral cut in the meat, limiting the depth of the cut to leave a central core of uncut meat around the support member, and, after slicing, removing the temporary support member, wherein said central core of uncut meat is of sufficient cross-section to cause the boneless sliced meat product to retain its shape when the support member is removed.

3. A boneless sliced meat product of claim 1, wherein the point of entry of the support member defines a first end and the point of exit of the support member defines a second end and wherein the meat is sliced to within 1 inch of said first and second ends.

4. A boneless sliced meat product of claim 1, wherein the point of entry of the support member defines a first end and the point of exit of the support member defines a second end and wherein the meat is sliced to within ½ of an inch of said first and second ends.

5. A boneless sliced meat product of claim 1, wherein the point of entry of the support member defines a first end and the point of exit of the support member defines a second end and wherein the meat is sliced to within ¼ of an inch of said first and second ends.

6. A boneless sliced meat product of claim 1, wherein the point of entry of the support member defines a first end and the point of exit of the support member defines a second end and wherein the meat is sliced to within ⅛ of an inch of said first and second ends.

7. A boneless sliced meat product of claim 1, wherein the point of entry of the support member defines a first end and the point of exit of the support member defines a second end and wherein the meat is sliced from within ¼ of an inch to within 1 inch of said first and second ends.

8. A method of slicing a boneless meat product comprising: inserting a temporary support member through the meat product, rotating the meat product around the axis of the support member, moving a blade into the meat product adjacent one end of the support member, with the blade lying in a plane substantially perpendicular to the longitudinal axis of the support member, moving the blade along an axis parallel to the axis of rotation of the support member to produce a spiral cut in the meat, limiting the depth of the cut to leave a central annular core of uncut meat around the support member, said core being of sufficient cross-section to cause the boneless sliced meat to retain its shape when the support member is removed, and, after slicing, removing the temporary support member.

9. An accessory for supporting a boneless meat product, for use in conjunction with a spiral meat slicer having upper and lower chucks, said accessory comprising: a spit assembly including a spit and a base for supporting said spit, said spit having an apex and a foot being attached to said base;
a stop member carried by said spit; and
a spindle assembly including an aperture for receiving the apex of said spit,
wherein the cross section of said spit and said corresponding aperture are designed for transferring torque from the spit to the spindle assembly.

10. An accessory of claim 8, wherein the spit and corresponding aperture have a substantially quadrilateral cross section.

11. An accessory of claim 8, wherein the spit and corresponding aperture have a substantially hexagonal cross section.

12. An accessory of claim 8, wherein the spit and corresponding aperture have a substantially cruciform cross section.

13. An accessory of claim 8, wherein the spit and corresponding aperture have a substantially pentagonal cross section.
